(19) United States
(12) Patent Application Publication
(10) Pub. No.: US 2009/0078334 A1
(43) Pub. Date: Mar. 26, 2009

(54) DOSAGE-DISPENSING DEVICE AND DOSAGE-DISPENSING UNIT WITH AN ELECTROSTATIC CLOSURE DEVICE

(75) Inventor: Bruno Nufer, Illnau (CH)

Correspondence Address: STANDLEY LAW GROUP LLP, 6300 Riverside Drive, Dublin, OH, 43017, US

(73) Assignee: Mettler-Toledo AG, Greifensee (CH)

(21) Appl. No.: 12/233,929

(22) Filed: Sep. 19, 2008

(30) Foreign Application Priority Data
Sep. 20, 2007 (EP) 07116850.4

(51) Int. Cl. B65B 3/26; B67D 5/58; B67D 3/00; B65D 47/00

(52) U.S. Cl. 141/83; 222/510; 222/561; 222/190

(57) ABSTRACT

A dosage-dispensing unit serving to store and dispense pulverous or granular dosage material has a housing which includes at least one receptacle space for dosage material and an outlet orifice connected to the receptacle space. The dosage-dispensing unit further includes at least one electrostatic coagulant means which affects the build-up and/or the break-down of a closure plug consisting of dosage material and/or of an aperture shutter consisting of dosage material in the outlet orifice. The closing or narrowing of the outlet orifice thus occurs as a result of the electrostatic attraction and coagulation of dosage material leading to at least partial obstruction of the outlet orifice with the dosage material by the build-up of a closure plug or an aperture shutter.

### CROSS-REFERENCE TO RELATED APPLICATIONS

This application claims a right of priority under 35 USC §119 from European patent application 07 11 6850.4, filed 20 Sep. 2007, the content of which is incorporated by reference as if fully recited herein.

### TECHNICAL FIELD

The present invention relates to a dosage-dispensing device for pulverous or granular dosage material.

### BACKGROUND OF THE ART

Dosage-dispensing devices of this kind are used in particular in measuring out small quantities of, for example, toxic substances with high precision into small target containers. Such target containers are often placed on a balance in order to weigh the quantity of substance delivered from the dosage-dispensing device, so that it can subsequently be processed further according to a given purpose.

The substance to be dispensed is held for example inside a source container which is equipped with a dosage-dispensing head. It is desirable that the substance to be dispensed be delivered to the outside through a small opening of the dosage-dispensing device, so that it can be filled into a container with a small aperture cross-section.

Dosage-dispensing devices for dry and/or pulverous bulk materials, for example color dyes, belong to the known state of the art and are in current use. For example in U.S. Pat. No. 5,145,009, a device for delivering doses of a substance is described which comprises a source container with a closable outlet at its underside. Serving as a closure element is a cone-shaped valve body whose diameter decreases in the upward direction and which can be vertically lowered to open an outlet orifice, which rotates when it is in its open position and is equipped with means for advancing the dosage material in the direction towards the outlet orifice. The source container is further traversed by a drive shaft which at the top of the source container protrudes from the latter and is coupled to a drive mechanism. During the dosage-dispensing process, the target container that is to be filled rests on a balance whose weighing signal is directed to a processor unit in the drive mechanism of the closure element. By using a balance to measure the amount of dosage material delivered, the closure element can be closed at the right moment when the target weight has been reached.

The dosage-dispensing device of the foregoing description has the disadvantage that it can grind up the dosage material during the dosage-dispensing process. However, this grinding effect is absolutely undesirable in biotechnically manufactured active substances, because in particular the surface structure of these substances is a key element in their effectiveness. Especially in the development phase of new active substances these surface structures must not be destroyed because otherwise this could lead to erroneous results in the experiments.

A variety of dosage-dispensing systems have been developed to remove this drawback. These dosage-dispensing systems also include for example the dosage-dispensing device disclosed in U.S. Pat. No. 7,134,459 B2 with a dosage-dispensing unit which, similar to a hypodermic syringe, aspirates powder from a container by means of an underpressure and expels the powder by means of an overpressure into a target container. However, a dosage-dispensing device of this kind is suitable only for larger dosage quantities in the range of grams, it is very inaccurate, and the range of powders that can be dispensed with it is very limited.

A range of powders, as the term is used here, means a diversity of powders which differ from each other in properties like grain size, flow capability, stickiness and the like.

A dosage-dispensing device is disclosed in U.S. Pat. No. 6,340,036, whose outlet orifice is closed off by the dosage material itself. Arranged in the outlet orifice is a ring-shaped semipermeable membrane which separates a hollow space from the outlet orifice. The building-up of the closure plug is accomplished by setting up an underpressure in the hollow space, while the destruction of the closure plug occurs through a burst of pressure. Following the activation of the suction device, particles are attracted up to the point where they have built up a nearly impervious layer over the semipermeable membrane, whereby a closure plug is formed which closes off the outlet orifice.

As in the case of the dosage-dispensing device described in U.S. Pat. No. 7,134,459 B2, the dosage-dispensing device described in U.S. Pat. No. 6,340,036 B1 is likewise only suitable for dispensing a very limited range of powders, and in the worst case only one specific powder for whose properties such as particle size, particle shape and the like the semipermeable membrane is designed. Namely, if a powder with very small particles is being dispensed, the pores of the semipermeable membrane are getting clogged up and cannot be broken loose again even with pressure bursts. This is the case in particular with hard, sharp-edged powder particles. If a powder with a very wide distribution of grain sizes is to be dispensed, this dosage-dispensing device will allow the smallest particles to pass through the pores and to cause damage and in particular contamination to the system that serves to generate the underpressure. Furthermore, when the closure plug is broken-down by means of a pressure burst, a large quantity of dosage material is ejected from the outlet orifice in a sudden spurt, so that the delivery quantity can hardly be controlled with precision.

In order to achieve the most precise dosage deliveries possible, the closure element described in U.S. Pat. No. 5,145,009 A is designed so that the aperture cross section of the outlet orifice can be varied within a stepless range of adjustment. In particular for small outlet aperture cross sections, the change of the mass flow rate from the outlet orifice does not vary proportionally with the variation of the outlet aperture cross section, and these factors need to be taken into account in the dosage-control algorithm. The variation of the mass flow rate in dosage-dispensing systems of this type is decisively influenced by the properties of the powder, such as particle size, particle shape, and the tendencies of the particles to coagulate and to adhere to the surfaces of the outlet orifice. As an additional aggravating factor, the powder properties of one and the same type of powder can change strongly, for example as a consequence of changing moisture content. Therefore, a rule is normally implemented in the dosage-control algorithm, that after a certain part of the dosage material has been delivered, the outlet aperture is reduced by means of the closure element to the point where only small amounts of dosage material come out and the outlet orifice is closed up entirely when the target weight is reached. A dosage delivery with dosage-dispensing systems of this kind is therefore very time-consuming.

The object of the present invention is to provide a dosage-dispensing unit, or a dosage-dispensing device, which allows dosage material in powder form to be delivered into a target container in precise doses, at a fast rate, and without damaging the material.

### SUMMARY

This task is solved through the features of the independent claim 1.

A dosage-dispensing unit, serving to store and dispense pulverous or granular dosage material, comprises a housing which has at least one receptacle space for dosage material and an outlet orifice connected to the receptacle space. The dosage-dispensing unit further comprises at least one electrostatic coagulant means which affects the build-up and/or the break-down of a closure plug consisting of the dosage material and/or of an aperture shutter consisting of the dosage material in the outlet orifice.

Thus, the closing or narrowing of the outlet orifice occurs through the electrostatic attraction and coagulation of dosage material for the build-up of a closure plug or an aperture shutter consisting of dosage material. In the interest of better readability, the electrostatically functioning means of attracting and coagulating the dosage material is referred to as an electrostatic coagulant means. It is of course considered self-evident that the dosage-dispensing device will only work satisfactorily, if the dosage material is capable of being electrostatically charged. Most insulating materials, for example organic compounds, possess these properties. To assist in the coagulation of dosage material that cannot be electrostatically charged, it is also possible to add an inert powder that is capable of electrostatic coagulation or, if the powder particles are electrically conductive, to provide them with an inert insulation coating.

It is possible that the dosage material filled into the receptacle space is already strongly charged from the filling process, so that it can form a closure plug without the coagulant means having to be activated. In this case, or if the closure plug does not fall apart on its own after the electrostatic coagulant means is switched off, it is also possible to use the electrostatic coagulant means to break down a closure plug, as described farther below.

In most powders with good flow properties, the closure plug falls apart immediately after the electrostatic coagulant means is switched off, whereby the outlet orifice is abruptly opened. As soon as the targeted quantity has been dispensed, the electrostatic coagulant means is activated whereby with the same abruptness a closure plug is formed and the outlet orifice is closed. This simplifies the dosage-control algorithm decisively because one does not have to be concerned with a continuous change of the outlet aperture cross-section and the problems that occur in connection with it. Furthermore, the abrupt opening and closing leads to significantly shortened dosage delivery times in comparison to dosage-dispensing devices with mechanical closure elements.

If only doses in the smallest amounts are to be dispensed or, in the case of very easy-flowing powders and granulates, to prevent that too much substance is dispensed, it is possible also to activate the electrostatic coagulant means only partially, so that an aperture shutter, consisting of dosage material, establishes itself and partially obstructs the outlet orifice. The remaining opening now continues to allow a mass outflow at a reduced rate.

The at least one electrostatic coagulant means can include at least one electrode, so that when a high voltage is applied to the electrode, particles of the dosage material can be electrostatically attracted to the coagulant means and can be coagulated.

As soon as the electrode is set under a direct voltage, the particles are attracted and form a closure plug which blocks the outlet orifice so that no dosage material can flow out, for example under the influence of gravity. Depending on the properties of the dosage material, it may be possible to separate the electrode from the voltage source immediately after the closure plug has been built up, while in some cases it may be necessary to keep the voltage applied. As soon as dosage material is to be dispensed, the electrode can be set to ground potential, the plug falls apart, and the dosage material begins to flow out of the outlet orifice. If grounding the electrode is not enough to cause the closure plug to break-down or disintegrate respectively, it is also possible to apply an alternating voltage to the electrode.

If the electrode was set, for example under a negative voltage to build up the closure plug, then the charge of the closure plug is known. As a means to assist the outflow of the particles or even to pull the closure plug out of the outlet orifice, a positively charged counter-electrode which attracts the negatively charged particles can be arranged in the vicinity of the bottom of the target container. Of course it is possible with this configuration to assist the dispensing process by means of an electrode which is set under a pulsed direct voltage.

Experiments with different powders have shown that a very broad range of powders can be handled with this dosage-dispensing technology. Particularly dosage material with a very low moisture content adheres very well to the electrostatic coagulant means.

Different possibilities are open in regard to the design and arrangement of the electrostatic coagulant means for the dosage-dispensing device.

In a first embodiment, the at least one electrostatic coagulant means can have the shape of a rod and can be arranged inside the housing immediately before or in the outlet orifice.

In a second embodiment, the at least one electrostatic coagulant means can be arranged outside of the housing immediately before or in the outlet orifice. In experiments with an ionizer which was arranged outside of the housing and oriented towards the outlet orifice, the activation of the ionizer led likewise to the build-up of a closure plug.

In a third embodiment, the at least one electrostatic coagulant means can be arranged in the form of a ring around the outlet orifice or in the outlet orifice.

If more than one electrostatic coagulant means is to be used, the foregoing design variants can of course be combined with each other. For example, a rod-shaped electrode can be arranged inside the housing, and a ring-shaped electrode in the outlet orifice.

Further, the rod-shaped electrostatic coagulant means or a rod-shaped closure element can be pushed against the outlet orifice by means of a spring element, in order to tightly close the outlet orifice. This prevents the uncontrolled escape of dosage material from the outlet orifice when the dosage-dispensing unit is being filled and/or when it is set into a dosage-dispensing device. By a linear displacement of the rod-shaped electrostatic coagulant means along its central longitudinal axis and against the direction of the spring force, the build-up of a closure plug and/or of a ring-shaped aperture shutter is enabled, and/or the outlet orifice is set free.

A linear movement of the rod-shaped electrostatic coagulant means or the rod-shaped closure element along its central longitudinal axis can also serve to vary the aperture cross-section of the outlet orifice. By this measure, it is possible to adapt the outlet aperture cross-section to the properties of the dosage material that is to be dispensed. It is further possible through this measure to dispense even the smallest quantities of dosage material very accurately. Furthermore, by reducing the outlet aperture cross-section, the direct voltage that needs to be applied to the electrode can be lowered.

With preference, the housing further has a fill opening connected to the receptacle space, which can be closed up with a closure cap or connected to a source container. This allows the dosage-dispensing unit to be filled in a problem-free manner with dosage material, and the latter does thus not have to be pushed into the receptacle space through the outlet orifice which is in most cases very small.

In order to be able to deliver dosage material from a dosage-dispensing unit, a dosage-dispensing device is required with at least one drive unit, at least one processor unit and at least one measuring unit serving to measure the dispensed dosage material. At least one dosage-dispensing unit is interchangeably connectable to said dosage-dispensing device. By means of the processor unit, the at least one coagulant means can be controlled dependent on the measurement signal of the measuring unit, whereby the build-up and break-down of a closure plug and/or a ring-shaped aperture shutter can be influenced.

The measuring unit can be a gravimetric measuring instrument, for example a balance or a weighing module, but it could also be a measuring system that is capable of registering and measuring the fill level of a target container or the volume amount that has been dispensed.

To assist the break-down of the closure plug or the aperture shutter, the drive unit of the dosage-dispensing device can be equipped with at least one actuator whose action is directed at the dosage material, in particular a vibrator or a stirring mechanism.

If very easy-flowing dosage material needs to be dispensed in doses of the smallest amounts, it is not necessarily required to generate an aperture shutter with the electrostatic coagulant means or with the rod-shaped closure element. The drive unit can also include a holder device to which the dosage-dispensing unit can be connected. The holder device can be designed so that it can be tilted by means of a tilting unit, particularly to take the flow properties of the dosage material into account.

### BRIEF DESCRIPTION OF THE DRAWINGS

Details of the dosage-dispensing unit and the dosage-dispensing device according to the invention are presented through the description of the embodiments illustrated in the drawings, wherein:

FIG. 1 is a perspective view of an embodiment of a dosage-dispensing device with a drive unit, a holder device, and a dosage-dispensing unit set into the holder device;

FIG. 2 is a sectional perspective view of an embodiment of the dosage-dispensing unit with an electrostatic coagulant means of ring-shaped configuration and with a rod-shaped closure element; and

FIG. 3 is a sectional perspective view of an embodiment of the dosage-dispensing unit with a source container, a sliding shutter and a rod-shaped electrostatic coagulant means.

### DETAILED DESCRIPTION OF THE EMBODIMENTS

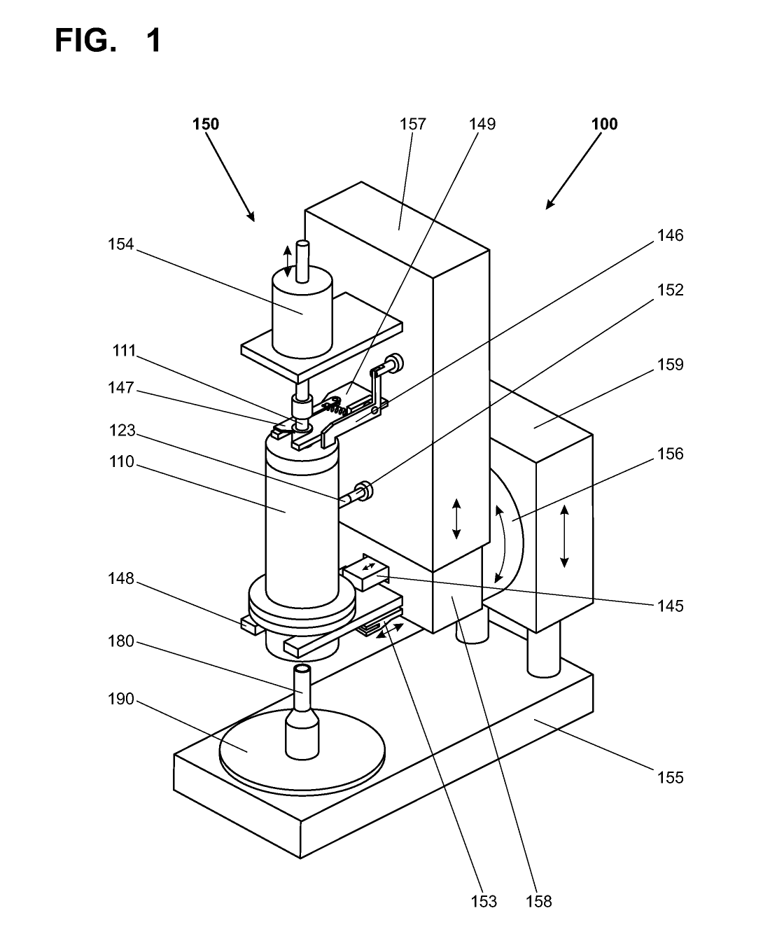

FIG. 1 shows a perspective view of a dosage-dispensing device 100 which has a drive unit 150 in which a dosage-dispensing unit can be set in place and subsequently removed again. The drive unit 150 includes a holder device which has an upper part 157 and a lower part 158 that are capable of linear movement away from and towards each other. This makes it possible to use dosage-dispensing units 110 of different lengths. In order to allow a simple exchange of the dosage-dispensing unit 110 and a safe and precise dispensing operation, the dosage-dispensing unit 110 and/or the holder device needs to be equipped with suitable mechanical, or possibly mechanical and electrical, connecting elements 149, 148, which complement each other for form-fitting mutual engagement. A horizontal latch 147 and a vertical latch 146 are arranged on the second mechanical connecting element 149 in order to secure the dosage-dispensing unit 110 in the holder device against falling out.

The dosage-dispensing unit 110 of FIG. 1 has a basically cylindrical shape. In principle, however, dosage-dispensing units with different shapes, for example with a square, hexagonal or octagonal exterior and interior cross-section, are likewise possible. The dosage-dispensing unit 110 seated in the drive unit 150 is shown with its longitudinal axis oriented in the vertical direction. As the holder device is tiltable connected by means of a tilting unit 156 to a vertically movable unit 159, the holder device can be turned about a horizontal axis into an inclined position. Through the tilting of the holder device, or rather of the dosage-dispensing unit 110, it is possible to influence the flow velocity of the dosage material coming out of the outlet orifice. This tilt axis lies preferably in the same horizontal plane as the outlet orifice (not visible here) of the dosage-dispensing unit 110. As a result, the center of the aperture cross-section of the outlet orifice will always remain in the same place even when the dosage-dispensing unit 110 is tilted into an inclined position, so that a target container 180 can always be set in the same spot. The vertically movable unit 159 is connected to a base plate 155 which also incorporates a measuring unit 190. The vertically movable unit 159 allows an adjustment of the distance between the outlet orifice and the measuring unit 190 which is set up vertically below the center point of the outlet aperture cross-section. This makes it possible to fill target containers 180 of different heights.

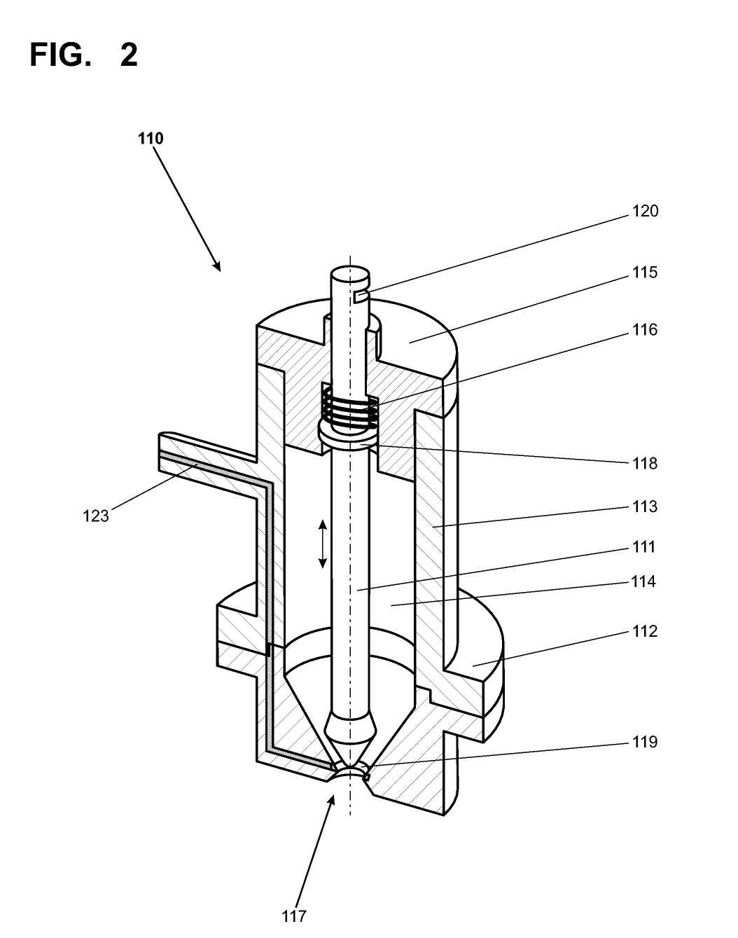

The design configuration of the dosage-dispensing unit 110 shown here is disclosed in detail in the description of FIG. 2. Besides the connections to the holder device, the dosage-dispensing unit 110 has two interfacing elements, one being represented by the end of a rod-shaped closure element 111 and the second being represented by the end of an electrical connection 123 which protrudes from the dosage-dispensing unit. The end of the rod-shaped closure element 111 is connected to a drive mechanism 154 which is fastened to the upper part 157 and provides the capability to generate a precisely controlled linear displacement. Of course, the closure element 111 can also include a stirring mechanism which serves to break up powder bridges in the receptacle space. If a stirring mechanism is present, the drive mechanism 154 can perform the additional function of setting the closure element 111 into rotation. The electrical connection 123 can be plugged into a connector socket 152.

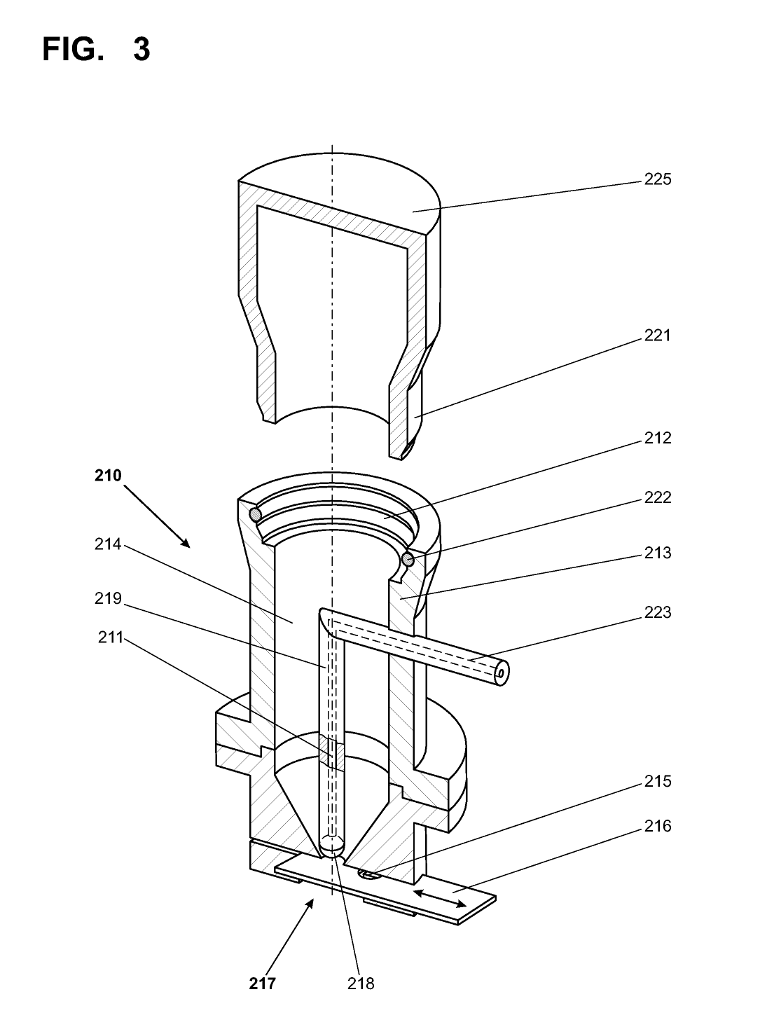

As shown in FIG. 1, the dosage-dispensing device 100 is further equipped with a slide-actuator mechanism 153 whose drive source is incorporated in the lower part 158 and which generates a horizontal movement. This allows the use of dosage-dispensing units which are equipped with a sliding shutter as shown in FIG. 3. Of course, the slide-actuator mechanism 153 can also be used to reduce the opening of the outlet orifice in order to produce an aperture control effect.

In order to assist the disintegration of a closure plug consisting of dosage material, the dosage-dispensing device 100 can include an actuator 145 capable of producing a suitable kind of action directed at the dosage-dispensing unit 110.

The dosage-dispensing unit 110 illustrated schematically in FIG. 2 in a perspective cutaway view has a housing 113 containing a receptacle space 114 for dosage material and an outlet orifice 117 which is connected to the receptacle space 114. The receptacle space 114 can be closed with a closure cap 115. Arranged in the closure cap 115 is a rod-shaped closure element 111 which is movable along its central longitudinal axis. The spring force of a spring element 116 which is likewise arranged in the closure cap 115 bears against a flange 118 that is arranged on the closure element 111 and pushes the latter in the direction towards the outlet orifice 117. As long as the closure element 111 is not coupled to the drive mechanism described in the context of FIG. 1, the outlet orifice 117 is tightly closed by the closure element 111. At the end of the closure element 111 that faces away from the outlet orifice, a coupling groove 120 is formed which allows a form-fitting engagement with the drive mechanism. After the coupling connection is engaged, the drive mechanism can open the outlet orifice 117 through a linear displacement of the closure element 111 in opposition to the spring force.

The closure cap 115 can be removed to fill the receptacle space 114. However, the closure element 111 should remain in the receptacle space 114, so that the outlet orifice 117 remains closed. Another possible way of filling the receptacle space is offered by the two-part housing 113 shown in FIG. 2, where the two parts are separable from each other for this purpose in the area of a flange 112 that is formed on the housing 113.

In the area of the outlet orifice 117 a ring-shaped electrostatic coagulant means 119 is arranged to which a voltage can be applied through the electrical connection 123.

By referring to FIGS. 1 and 2, a typical dosage-delivery process can now be explained as follows: After a dosage-dispensing unit 110 filled with dosage material has been set into the drive unit 150 and the mechanical and electrical connections have been coupled together, the process of dispensing dosage material from the dosage-dispensing unit 110 can be started. In a first step, a voltage is applied to the electrostatic coagulant means 119. In a second step, a linear move of the closure element 111 mechanically opens up the outlet orifice 117 while at the same instant a closure plug consisting of dosage material is formed as a consequence of the voltage applied to the coagulant means 119. In a third step, the applied voltage is reduced or the electrostatic coagulant means 119 is separated from the voltage supply, so that the closure plug falls apart and the dosage material begins to flow out of the dosage-dispensing unit 110 under the influence of gravity. If the respective capabilities are provided, the flow behavior of the dosage material can be influenced by applying an alternating voltage to the electrostatic coagulant means 119, or the break-down of the closure plug and the flow behavior of the dosage material can be influenced by means of the actuator 145 described in the context of FIG. 1. Instead of or in combination with the actuator 145, it is also possible to impart vibrations to the closure element 111 through the drive mechanism 154.

As soon as the measurement unit 190 signals that the dispensed quantity of dosage material equals the target weight, the electrostatic coagulant means 119 is immediately supplied with direct voltage and the outlet orifice 117 is closed. Depending on the free-fall height and the mass flow rate of the dosage material, it is possible to take the dosage material in free fall between the dosage-dispensing unit 110 and the bottom of the target container 180 into account by measuring the mass flow rate during the dosage delivery and also entering the free-fall height into the calculation in order to activate the electrostatic coagulant means 119 accordingly before the target weight has been reached.

For exceptionally easy-flowing dosage material, the electrostatic coagulant means can be activated only to a partial extent, whereby the outlet orifice can be partially closed with an aperture shutter consisting of dosage material. A partial activation can be achieved either by reducing the voltage or by a segmented design and selective segment control of the electrode or electrodes built into the electrostatic coagulant means.

FIG. 3 illustrates a second embodiment of a dosage-dispensing unit 210 according to the invention in a perspective cutaway view. The dosage-dispensing unit 210 has a housing 213 with a fill opening 212 formed at its upper end. An outlet orifice 217 is formed at the lower end of the housing 213. The interior of the housing 213 between the outlet orifice 217 and the fill opening 212 contains a receptacle space 214 for dosage material. By way of the fill opening 212 a source container 225 can be connected to the housing 213 of the dosage-dispensing unit 210. To prevent contaminants from entering, the fill opening has a seal 222 which makes a tight-fitting seat for the sealing surface 221 of the source container 225 when the latter is connected to the housing 213 and which seals this juncture against outside influences and/or against the escape of dosage material.

In the receptacle space 214 a rod-shaped electrostatic coagulant means 219 is arranged whose lower end is located in the area of the outlet orifice 217. The upper end is connected to an electrical connection 223 which is oriented at a right angle to the central longitudinal axis of the rod-shaped coagulant means 219 and leads out of the housing 213.

As shown in FIG. 3, the rod-shaped coagulant means 219 consists of a central conductor 211 which is surrounded by a thick layer of insulation. A ball-shaped electrode 218 is arranged at the lower end of the coagulant means 219 and connected to the central conductor 211. Of course many different shapes of electrodes are conceivable, such as star-shaped electrodes, grid electrodes, sieve electrodes with cylindrical holes, and similar designs.

There is further a slide shutter 216 with a passage opening 215 arranged in the area of the outlet orifice 217. As soon as the passage opening 215 is moved into the area of the outlet orifice 217 by changing the position of the shutter 216, the outlet orifice 217 is opened up and the dosage material can flow out of the dosage-dispensing unit 210. To prevent this from happening unintentionally, the electrostatic coagulant means 219 can also be energized with a voltage before moving the slide shutter 216.

Of course, the embodiments shown in FIGS. 2 and 3 can be combined with each other. Dosage-dispensing units with a combination of rod-shaped and ring-shaped electrodes are conceivable. Furthermore, instead of a closure element, the rod-shaped electrode can be arranged with linear mobility. As a further note, a combination of a closure element and a slide shutter is especially advantageous for the storage and handling of particularly toxic substances.

What is claimed is:

1. A unit for storing and dispensing a dosage material in powder form, comprising:
a housing which has at least one receptacle space for dosage material and an outlet orifice connected to the receptacle space; and
a means for electrostatically coagulating the dosage material to establish, or break down, an at least partial obstruction of the outlet orifice with the dosage material.

2. The dosage-dispensing unit of claim 1, wherein:
the electrostatic coagulant means comprises an electrode, such that a high voltage applied to the electrode attracts and coagulates particles of the dosage material.

3. The dosage-dispensing unit of claim 2, wherein:
the electrostatic coagulant means is set under a voltage from a direct current.

4. The dosage-dispensing unit of claim 2, wherein:
the electrostatic coagulant means is set under a voltage from an alternating current.

5. The dosage-dispensing unit of claim 2, wherein:
the electrostatic coagulant means is configured in the shape of a rod and is arranged inside the housing immediately before or in the outlet orifice.

6. The dosage-dispensing unit of claim 2, wherein:
the electrostatic coagulant means is further arranged outside of the housing immediately before or in the outlet orifice.

7. The dosage-dispensing unit of claim 6, wherein:
the electrostatic coagulant means is arranged in the shape of a ring around the outlet orifice.

8. The dosage-dispensing unit of claim 7, further comprising:
a rod-shaped closure element, having a central longitudinal axis aligned with the outlet orifice; and
a spring element, arranged to normally push the rod-shaped closure element against the outlet orifice to tightly close the outlet orifice;
such that a linear displacement of the rod-shaped closure element along the longitudinal axis against the force of the spring element enables the build-up of an at least partial obstruction of the outlet orifice or opens the outlet orifice.

9. The dosage-dispensing unit of claim 8, wherein:
an aperture cross-section of the outlet orifice is varied by the linear movement of the rod-shaped closure element along the longitudinal axis thereof.

10. The dosage-dispensing unit of claim 1, further comprising:
a fill opening in the housing, connected to the receptacle space; and
a closure cap or a source container for closing the fill opening.

11. The dosage-dispensing unit of claim 1, further comprising:
a slide shutter serving to close the outlet orifice.

12. The dosage-dispensing unit of claim 1, wherein:
the electrostatic coagulant means is configured in the shape of a rod and is arranged inside the housing immediately before or in the outlet orifice.

13. The dosage-dispensing unit of claim 1, wherein:
the electrostatic coagulant means is arranged outside of the housing immediately before or in the outlet orifice.

14. The dosage-dispensing unit of claim 5, further comprising:
a slide shutter serving to close the outlet orifice.

15. A dosage-dispensing device, comprising:
a drive unit;
a processor unit; and
a measuring unit for continuously measuring the dispensed dosage material, and
a dosage-dispensing unit according to claim 1;
wherein the dosage dispensing unit is interchangeably connectable to the dosage-dispensing device such that the electrostatic coagulant means is controlled by the processor unit, based on a measurement signal from the measuring unit, to effect the build-up and break-down of an at least partial obstruction of the outlet orifice by the dosage material.

16. The dosage-dispensing device of claim 15, further comprising:
an actuator for the drive unit whose action is directed at the dosage material, in particular a vibrator or a stirring mechanism.

17. The dosage-dispensing device of claim 15, further comprising:
a holder device for the drive unit;
a vertically movable unit for the drive unit; and
a tilting unit, arranged between the vertically movable unit and the holder device;
wherein the dosage-dispensing unit can be connected to the holder device and the holder device can be tilted relative to the vertically movable unit.
